(19) United States
(12) Patent Application Publication
(10) Pub. No.: US 2023/0311193 A1
(43) Pub. Date: Oct. 5, 2023

(54) ROLLER HEMMING APPARATUS

(71) Applicant: HONDA MOTOR CO., LTD., Tokyo (JP)

(72) Inventors: Keita BABA, Tokyo (JP); Takuo KOBAYASHI, Tokyo (JP); Masaaki TSUTSUMI, Tokyo (JP); Nobuya KAWASAKI, Tokyo (JP); Hironori TARUI, Tokyo (JP); Masaji KOJIMA, Tokyo (JP); Kazumasa ISHIBASHI, Tokyo (JP)

(21) Appl. No.: 18/189,227

(22) Filed: Mar. 24, 2023

(30) Foreign Application Priority Data
Mar. 30, 2022 (CN) 202210331134.6

(51) Int. Cl. B21D 39/02

(52) U.S. Cl. CPC B21D 39/023

(57) ABSTRACT

Provided is a roller hemming apparatus capable of preventing positional misalignment of a lower plate workpiece during a bending process. A roller hemming apparatus of the present disclosure includes a die configured to hold a first workpiece which is a plate material, and a roller configured to bend an edge of the first workpiece onto an edge of a second workpiece, which is a plate material placed on the first workpiece held in the die, to overlap each other, the die including a suction mechanism that opens toward a workpiece contact surface against which a hem flange on a peripheral edge of the first workpiece abuts, and that suctions the first workpiece. Thus, positional misalignment of the first workpiece is prevented during a hemming process.

This application is based on and claims the benefit of priority from Chinese Patent Application No. 202210331134.6, filed on 30 Mar. 2022, the content of which is incorporated herein by reference.

### BACKGROUND OF THE INVENTION

### Field of the Invention

The present invention relates to a roller hemming apparatus.

### Related Art

For machining of edges of a bonnet, a trunk, and doors in a vehicle body, a roller hemming apparatus may be applied in which a skin as a lower plate workpiece is bent so as to cover a frame as an upper plate workpiece by rollers. A roller hemming apparatus has been proposed in which a plurality of reciprocally movable hemming dies are provided on a plurality of transport rails corresponding to parts with different specifications for each vehicle type (for example, see Japanese Unexamined Patent Application, Publication No. 2013-86181). According to the roller hemming apparatus disclosed in Japanese Unexamined Patent Application, Publication No. 2013-86181, the parts with different specifications can be subjected to hemming at high speed. In addition, a technique has also been proposed to improve in a degree of freedom of follow-up operation in a manner that a follow-up apparatus applied to support a workpiece during or after bending is configured to change independently an inclined angle and an elevation position of a support stand for supporting the workpiece (for example, see Japanese Unexamined Patent Application, Publication No. 2021-115615).

Patent Document 1: Japanese Unexamined Patent Application, Publication No. 2013-86181

Patent Document 2: Japanese Unexamined Patent Application, Publication No. 2021-115615

### SUMMARY OF THE INVENTION

In the process of bending a lower plate workpiece so as to cover an upper plate workpiece with rollers, it is necessary to determine relative positions of the lower and upper plate workpieces and superimpose the lower and upper plate workpieces, and to fix them in that state, so that the lower and upper plate workpieces are not misaligned. However, the position of the lower plate tends to be misaligned during bending. In order to prevent such positional misalignment, when the upper and lower plates are pressed against a die with a position fixing pad at a portion where the lower and upper plate workpieces overlap, a problem will occur in which outer surfaces of the plate workpieces are scratched. Further, there is also a method of holding a lower plate with a normal vacuum cup; however, the vacuum cup uses a viscoelastic substance such as rubber or urethane in order to correct a variation in suction position, and there arises a problem due to elasticity that positional misalignment occurs when a force is applied in bending the workpiece. None of Japanese Unexamined Patent Application, Publication No. 2013-86181 and Japanese Unexamined Patent Application, Publication No. 2021-115615 discloses a method of coping with the positional misalignment of the lower plate workpiece that occurs during the bending process.

The present invention has been made in view of the above-described circumstances, and is to provide a roller hemming apparatus capable of preventing positional misalignment of a lower plate workpiece during a bending process.

(1) The present invention provides a roller hemming apparatus (for example, a roller hemming apparatus 1 to be described below) including a die (for example, a die 2 to be described below) configured to hold a first workpiece (for example, a first workpiece 7 to be described below) which is a plate material, and a roller (for example, a roller 3 to be described below) configured to bend an edge (for example, an edge 9 to be described below) of the first workpiece onto an edge (for example, an edge 10 to be described below) of a second workpiece (for example, a second workpiece 8 to be described below), which is a plate material placed on the first workpiece held in the die, to overlap each other, the die including a suction mechanism (for example, a suction mechanism 12 to be described below) that opens toward a workpiece contact surface (for example, a workpiece contact surface 13 to be described below) against which a hem flange (for example, a hem flange 11 to be described below) on a peripheral edge of the first workpiece abuts, and that suctions the first workpiece.

(2) In the roller hemming apparatus according to (1) above, the suction mechanism performs an air purge prior to suctioning the first workpiece.

In the roller hemming apparatus according to (1) above, the suction mechanism in the die opens toward the workpiece contact surface, against which the hem flange on the peripheral edge of the first workpiece abuts, to suction the first workpiece 7. For this reason, the positional misalignment of the first workpiece is prevented in the process of bending the peripheral edge of the first workpiece to cover the edge of the second workpiece.

In the roller hemming apparatus according to (2) above, the suction mechanism performs the air purge prior to suctioning the first workpiece. For this reason, it is possible to remove in advance foreign matter that has entered the suction hole of the suction mechanism and foreign matter that may be caught between the die and the first workpiece. Therefore, the function of suctioning the first workpiece in the suction mechanism is not hindered by foreign matter.

### BRIEF DESCRIPTION OF THE DRAWINGS

FIG. 1 is a diagram schematically showing a roller hemming apparatus according to an embodiment of the present invention;

FIG. 2 is a diagram shows a die and a roller of the roller hemming apparatus according to the embodiment of the present invention;

FIG. 3 is a diagram schematically showing a surface of the die facing a workpiece in the roller hemming apparatus according to the embodiment of the present invention;

FIG. 4 is a diagram schematically showing a partial cross section of a suction mechanism in the roller hemming apparatus according to the embodiment of the present invention;

FIG. 5 is a diagram schematically showing a cross section of another part of the suction mechanism in the roller hemming apparatus according to the embodiment of the present invention; and

FIG. 6 is a diagram schematically showing a cross section of further another part of the suction mechanism in the roller hemming apparatus according to the embodiment of the present invention.

### DETAILED DESCRIPTION OF THE INVENTION

An embodiment of the present invention will be described below with reference to the drawings.

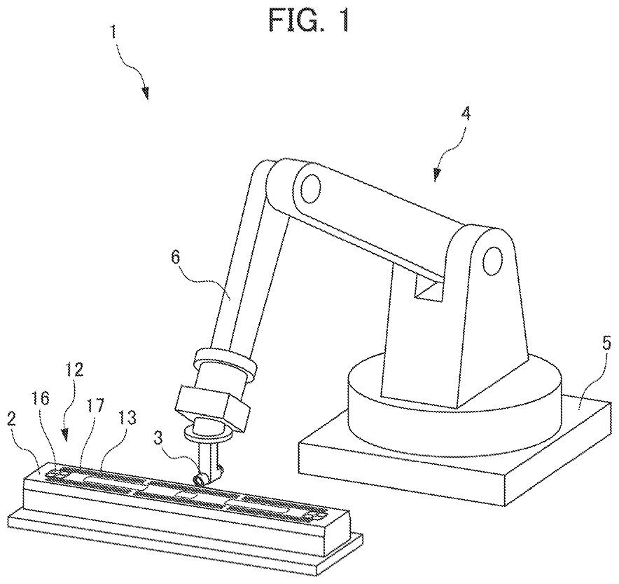

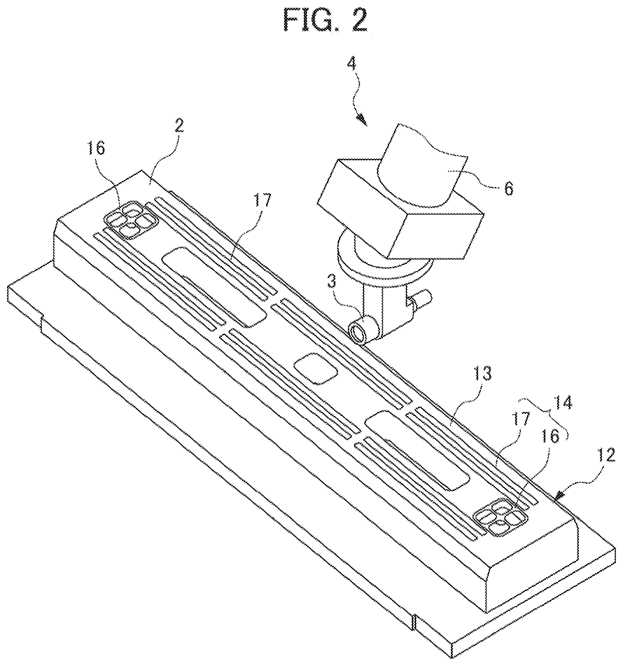

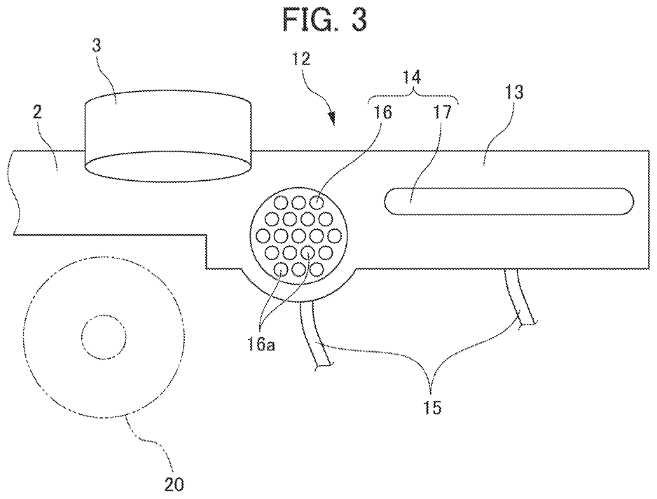

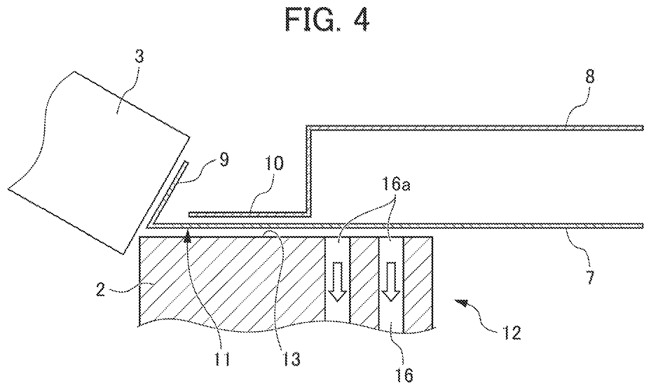

FIG. 1 schematically shows a roller hemming apparatus 1 according to an embodiment of the present invention. FIG. 2 shows a die 2 and a roller 3 of the roller hemming apparatus 1. FIG. 3 schematically shows a surface of the die 2 facing a workpiece. FIG. 4 schematically shows a partial cross section of a suction mechanism in the roller hemming apparatus 1. The roller hemming apparatus 1 includes a die 2 and a roller 3. A robot 4 controls three-dimensional position and posture of the roller 3. The robot 4 includes a base 5 that supports a whole body and an arm 6 that movably supports the roller 3, and changes the three-dimensional position and posture of the roller 3 in time series based on predetermined teaching.

During a roller hemming process, a first workpiece 7 being a plate material is held by the die 2, and a second workpiece 8 being a plate material is placed on the first workpiece 7 at a predetermined relative position. The position and posture of the roller 3 are controlled by the robot 4 that has been taught, and as schematically shown in FIG. 4, the roller 3 bends an edge 9 of the first workpiece 7 onto an edge 10 of the second workpiece 8 to overlap.

The die 2 includes a suction mechanism 12 that opens to a workpiece contact surface 13 against which a hem flange 11 on a peripheral edge of the first workpiece 7 abuts, and that suctions the first workpiece 7. Here, the inside means an inside relative to an outside as viewed from an outside of the die 2. More specifically, the suction mechanism 12 is provided inside compared with a state where the edge 9 of the first workpiece 7 is bent onto the edge 10 of the second workpiece 8 to overlap. Therefore, it is possible to prevent an outer surface of the workpiece of the plate material from being scratched by the suction mechanism 12 during bending. The suction mechanism 12 includes a suction hole 14 opened to the workpiece contact surface 13 of the die 2, a suction hose 15 connected to a rear of the suction hole 14, and a pump (not shown) connected to the other end of the suction hose 15. In the description, the suction hole 14 is a general term for a first form suction hole 16 having a plurality of pores 16a that are openings with a relatively small diameter and a second form suction hole 17 having an oblong hole-like opening. In the course of bending the edge 9 of the first workpiece 7 onto the edge 10 of the second workpiece 8 to overlap, a relative position of the first workpiece 7 and the second workpiece 8 is maintained in a regular relationship by the suction mechanism 12 of the die 2.

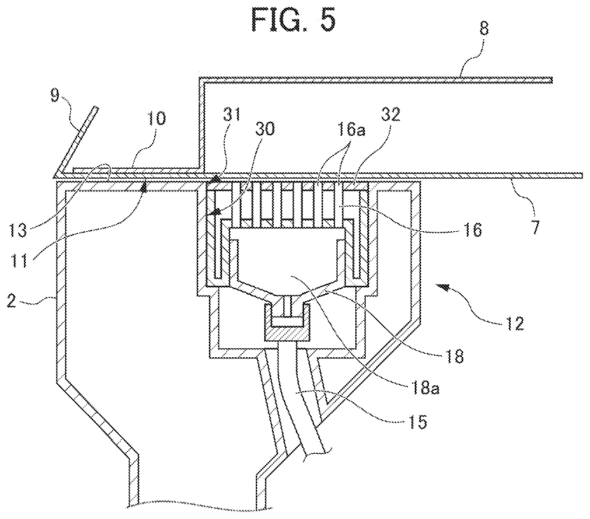

FIG. 5 shows an example of a mechanism for connecting the first form suction hole 16 to the suction hose 15. An assembly cone 18 is interposed between each of the pores 16a and the suction hose 15 so as to cover rears of the pores 16a of the first form suction hole 16 penetrating a lid member 32 installed in an opening 31 of a bore 30 drilled at a predetermined depth from the workpiece contact surface 13. A chamber 18a having a constant volume is formed between rear sides of each of the pores 16a and the assembly cone 18, and a suction force of the suction hose 15 uniformly acts on each of the pores 16a.

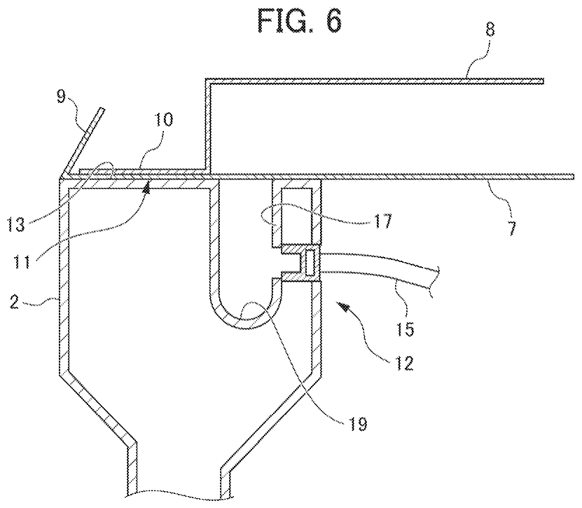

FIG. 6 shows an example of a mechanism for connecting the second form suction hole 17 to the suction hose 15. The second form suction hole 17 opened in an oblong hole-like shape in the workpiece contact surface 13 shown in FIGS. 1 to 3 includes a deep groove 19, which is deeper than a short dimension of the opening, behind the opening. A tip side of the suction hose 15 is connected to a groove wall provided between a groove bottom of the deep groove 19 and the opening.

In the roller hemming apparatus 1 described with reference to FIGS. 1 to 6, as described above, when the first workpiece 7 is placed on the workpiece contact surface 13 of the die 2, air is blown out from the suction hose 15, and thus an air purge is applied to the workpiece contact surface 13, the surface of the first workpiece 7 facing the die 2, and the suction hole 14. The air for the air purge is prepared in a pressure container such as a gas cylinder or a pressurization chamber (not shown), and is discharged to the suction hose 15 when a valve mechanism on an outlet side of the container is switched to an open state at a timing of the air purge. Thus, the air for the air purge is jetted from the suction hole 14 through the suction hose 15. In other words, the suction mechanism 12 has a configuration in which an air purge is performed prior to the suction of the first workpiece 7.

According to the roller hemming apparatus 1 of the present embodiment, the following effects are obtained.

In the roller hemming apparatus 1 according to (1) above, the suction mechanism 12 in the die 2 is provided inside the position, where the hem flange 11 on the peripheral edge of the first workpiece 7 abuts, to suction the first workpiece 7. For this reason, the positional misalignment is prevented in the process of bending the edge 9, which is the peripheral edge of the first workpiece 7 to cover the edge 10 of the second workpiece 8.

In the roller hemming apparatus 1 according to (2) above, the suction mechanism 12 performs an air purge prior to suctioning the first workpiece 7. For this reason, it is possible to remove in advance foreign matter that has entered the suction hole 14 of the suction mechanism 12 and foreign matter that may be caught between the die 2 and the first workpiece 7. Therefore, the function of suctioning the first workpiece 7 in the suction mechanism 12 is not hindered by foreign matter.

Although an embodiment of the present invention has been described above, the present invention is not limited thereto. Appropriate changes may be made within the scope of the present invention. For example, as shown in FIG. 3, the suction mechanism 12 configured to suction the first workpiece 7 may be combined with the normal vacuum cup 20 to suction the first workpiece 7.

### EXPLANATION OF REFERENCE NUMERALS

1 . . . roller hemming apparatus
2 . . . die
3 . . . roller
4 . . . robot
5 . . . base
6 . . . arm
7 . . . first workpiece
8 . . . second workpiece
9 . . . edge
10 . . . edge
11 . . . hem flange
12 . . . suction mechanism
13 . . . workpiece contact surface
14 . . . suction hole
15 . . . suction hose
16 . . . first form suction hole
16a . . . pore
17 . . . second form suction hole
18 . . . assembly cone
18a . . . chamber
19 . . . deep groove
20 . . . vacuum cup
30 . . . bore
31 . . . opening
32 . . . lid member

What is claimed is:

1. A roller hemming apparatus comprising a die configured to hold a first workpiece which is a plate material, and a roller configured to bend an edge of the first workpiece onto an edge of a second workpiece, which is a plate material placed on the first workpiece held in the die, to overlap each other,
the die including a suction mechanism that opens toward a workpiece contact surface against which a hem flange on a peripheral edge of the first workpiece abuts, and that suctions the first workpiece.

2. The roller hemming apparatus according to claim 1, wherein the suction mechanism performs an air purge prior to suctioning the first workpiece.
